(19) United States
(12) Patent Application Publication
(10) Pub. No.: US 2003/0227602 A1
(43) Pub. Date: Dec. 11, 2003

(54) Image laser projector that using a laser source and a digital or analog mask projects an image in particles suspended in the air

(76) Inventor: Alberto Scarasso, Austin, TX (US)

Correspondence Address: ALBERT SCARASSO, 1406 BAY HILL DRIVE, AUSTIN, TX, 78746, US

(21) Appl. No.: 10/164,257

(22) Filed: Jun. 7, 2002

(51) Int. Cl. G03B 21/00

(52) U.S. Cl. 353/122

(57) ABSTRACT

An image laser projector that, using a laser source and a digital or analog mask (“mask”), projects an image in particles suspended in the air. A laser generator emits a beam that on impact with suspended particles, energizes these particles making them visible. A mask with an image is positioned in the path of the laser beam. The mask is a component consisting of a mechanism that blocks, filters, or shapes portions of the laser light beam from being projected. Hence, the resulting laser beam is shaped into an image that gets projected into the particles in the air. The mask is connected to an electronic controller that enables external inputs to select different stored masks (images) to be projected. The instructions on how to create or select a mask are stored in the image laser projector.

### Related U.S. Application Data Provisional Application Number 60/293,920 filed on May 29, 2001.

### BACKGROUND OF THE INVENTION

This invention relates to a laser projector that uses the presence of particles in the air, as a continuous screen in which a beam, shaped into an image, symbol or characters (“Information”), is used to communicate information to a viewer. In the absence of particles in the air the image is absent. The projected image beam has a dimensional longitudinal viewing. The presence of particles in the air can be the result of a natural phenomenon or the result of a process for the creation of the particles in the air in a closed environment.

Furthermore, this invention relates to the use of an electronic mechanism that associates signal inputs to stored images, symbols or characters, and uses them to shape the beam of a source of light into projected image beams to communicate certain information to the viewer.

According to another aspect of this invention, an external storage component, such as a smart chip or the like, can be used to store images, symbols or characters and associate them to signal inputs. The smart chip can also include firmware updates. The device of this invention will use the stored information from this external storage component. Using this approach the same laser projector device is capable of defining different sets of information applications and communication settings.

### SUMMARY OF THE INVENTION

### According to the invention, an image laser projector includes a source of light created by a laser generator to project a beam that once filtered by a mask, either analog or digital, shapes the beam into the image presented in the mask and projects the projected image beam into particles that are suspended in the air. The combination of the laser light and the mask shapes the laser beam into images, symbols, or characters that is permeated throughout the entire beam. The projected image beams, generated with the device of this invention, can be used to communicate information to a viewer. A viewer standing in the path of the beam, or within 30 degrees range of the beam, will have a crisp longitudinal, dimensional view of the image. The size of the image depends on the distance of the particles in the air from the laser projector and the distance of the mask to the optical subsystem (e.g. a lens) of the source light source generator. The crispiness of image depends on the density of the particles in the air. The longitudinal continuity of the image along the beam depends on the density of particles being continuous in the air along the path of the beam.

According to one aspect of this invention, the image laser projector uses a digital controllable mask controlled by a logic unit (microprocessor, circuitry, ASIC) to present different sets of information based on different input signals that the device of this invention may receive. The digital controllable mask creates different masks, representing images, symbols, or characters, in a panel that is located in the path of the light beam and that shapes the beam. The controllable mask can be made using a LCD panel, micro mirror arrays, micro filters arrays that change the spatial frequencies, micro-rotating mirrors or the like. The image laser projector may alternatively use an analog controllable mask in which the images, symbols, characters are etched into a beam shaper lens, such as diffractive optics or diffuser, that re-maps the input intensity to create the image, masks, or the like and are positioned into the path of the beam by a mechanism.

According to another aspect of this invention, the laser projector maps or converts external signal inputs into fixed images, symbols, or characters (“Information”) that are stored in the device of this invention. This includes Information that can be stored in an external store component such as a smart chip and inserted before operation of the device of this invention.

These and other aspects and advantages of the invention will be better understood by reference to the following detailed description taken in conjunction with the accompanying drawings.

### BRIEF DESCRIPTION OF THE SEVERAL VIEWS OF THE DRAWING

FIG. 1 is a block diagram of the laser projector device;

FIG. 2 is a digital controllable mask with project beam image according to one embodiment of this invention;

FIG. 3 is an analog controllable mask display according to another embodiment of this invention;

FIG. 4 shows multiple sources of light according to another embodiment of this invention;

FIG. 5 is a diagram of a storing component using a smart chip;

### DETAILED DESCRIPTION OF THE INVENTION

Referring to the FIG. 1, this invention is comprised of the following:

10 Light source generator and optical subsystem.

20 Projected image beam.

30 Electronically controllable mask.

40 Controller

50 Input signals

60 Store component

The light source generator and optical subsystem (10) uses light emitters, such as laser and laser diodes that emit light that are spatially coherent coupled with the optical subsystem (e.g. a lens) to further collimate the light beam. For single colored images, a colored laser (e.g., red light, green, and white) is used which permits the emission of differently colored laser beams. Multiple source generator and optical subsystem (10) can be organized within a geometric pattern to create a larger width collimated beam. Although, typically other type of lights do not output coherent light, as it is known in the art, optical subsystem can be used to shrink and focus the light from other light emitters such as LED. Also LED light coupled with a single mode optical fiber creates an emitter source that outputs light approximating coherent light. For multi color images, multiple colored lasers emitters are used in combination with lenses and mirrors that collimate the different emitted light beams into a single output beam.

The projected image beam (20) is the output of the beam generated by the light source generator and optical subsystem (10) and shaped by the electronically controllable mask (30). The projected image beam becomes visible with the presence of certain type of particles suspended in the air. The higher the density of this particle the more visible and crisp is the image. The distance range of the projected image beam depends on the power of the light source generator and optical subsystem (10). The image is created throughout the entire length of the beam, creating the longitudinal view. The beam and the size of the image increase with the distance of the viewers from the light source. The distance of the electronically controllable mask (30) from the light source generator and optical subsystem (10) can further control the size of the beam and the image.

An electronically controllable mask (30) that is located within a certain distance in the path of the source of light (10) and the projected image beam (20). The electronically controllable mask (30) can be positioned between the light generator and the optical subsystem in (10). The electronically controllable mask (30) can be positioned between the components of optical subsystem in (10). The controllable mask can be created by different methods. The concept of controllable mask implies that different masks can be created or positioned in the path of the light. These masks transform the beam generated by (10), creating a new projected image beam (20) that has an encoded image produced by the mask. Controllable also implies that the masks are the result of input signals. The controllable mask can be made of different materials and properties. Digital mask consist of a plurality of selectively active (“on” or “off”, open or close) elements. These elements have the properties to block or substantially attenuate the light-by blocking, attenuating, changing the distribution, or filter the spatial frequencies of the light-when activated or closed. Digital masks include, but are not limited to, liquid crystal display (LCD), dynamic diffractive lens, micro mirror array, micro-rotating mirrors or the like that are commercially available. For example, the transparent LCD mask has discrete, addressable pixels in which the activated (on,off) pixel block the light and inactive pixel (transparent) let the light pass through. Similar micro mirror arrays or other filters can shape the distribution or the spatial frequencies creating the equivalent of a mask with conceptually similar behavior to the LCD mask. The LCD's pixels (mirrors or filter behavior) are managed by a controller (40) that selectively activates and deactivates pixels to define an image, symbol, characters (“Information”). As it is known in the art, there are other technologies that provide the ability to create a digital mask. Analog mask consists of, but are not limited to, beam shapers that have etched a way to change or transform the shape of a laser beam by re-mapping the beam intensity, changing the distribution profile, or by enhancing and reducing the spatial frequencies of a beam of light. The panels are connected to a motor, other type mechanical devices, or micro-rotors which under the commands of the controller (40) position the Information in the path of (10).

The controller (40) is a logic unit that maps the input signals (50) to an image, symbol, or characters (“Information”) stored in the store component (60) in the form of encoded electronic commands. The controller is a logic unit that translates these commands into instructions that activate/deactivate the addressable elements of the electronically controllable mask (30). Alternatively, it translates these commands into instruction to position an analog mask of (30). The controller logic units can be implemented in a field programmable gate array, customized processor, microprocessor firmware, application specific integrated circuit (ASIC), or the like. For analog input signal (50), the controller has an Analog/Digital (A/D) converter.

The store component (60) contains electronic instructions describing images, symbols, and characters of text (“Information”) that are associated to input signals (50). These instructions depend on the type of controllable mask. For a digital controllable mask, it (60) has instructions on how to convert the Information into a mask using the addressable elements of (30). For an analog controller mask, it (60) has instructions on how to position the predefined masks in (30) in the path of light. The store component can be implemented using ROM, EPROM, or the like.

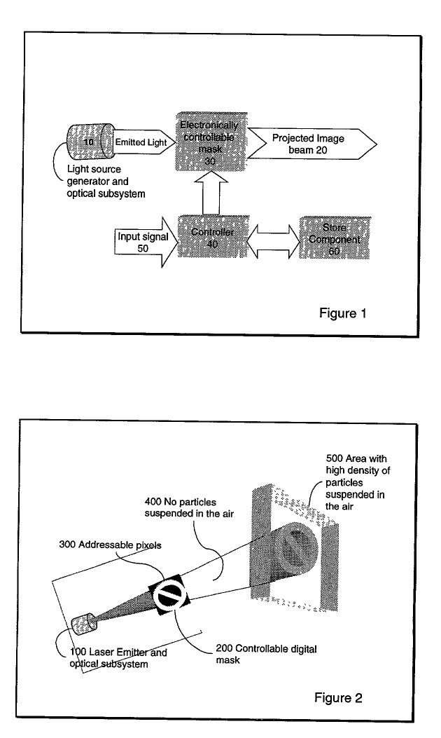

Referring now to the FIG. 2, a light source generator (100) emits a beam towards a controllable digital mask (200) that has a plurality of addressable pixels (300). As illustrated, the controller activates the pixel in the transparent digital mask, or activates the mirror or filter to change the range of selected spatial frequencies. Activating the pixel, mirror, or filter means that the pixel area becomes active and blocks, attenuates, changes the distribution, redirect, or the filter spatial frequencies of the light. Where the controller does not activate the pixel areas, represented in the circle with the line across, the light passed through, is shaped or blocked. As demonstrated by this embodiment, when particles are not suspended in the air (400) the beam is not visible. In areas where there is a certain particle density suspended in the air (500) the beam becomes visible, and the flat image of the electronically controllable mask (200), shapes the beam into a hollow dimensional circle with a line across. This embodiment is intended for illustration and not to imply or limit this invention.

Referring now to the FIG. 3, a light source generator (100) emits a beam towards an analog controllable mask (150) that has a plurality of defined masks (310). As illustrated, the controller activates the motor to position one of the defined masks in front of the path of light of (100). As described in the embodiment of FIG. 2, the image of the mask shapes the beam projected. Part of the mechanical system has a reset position that helps to ensure the known starting point. This embodiment is intended for illustration and not to imply or limit this invention.

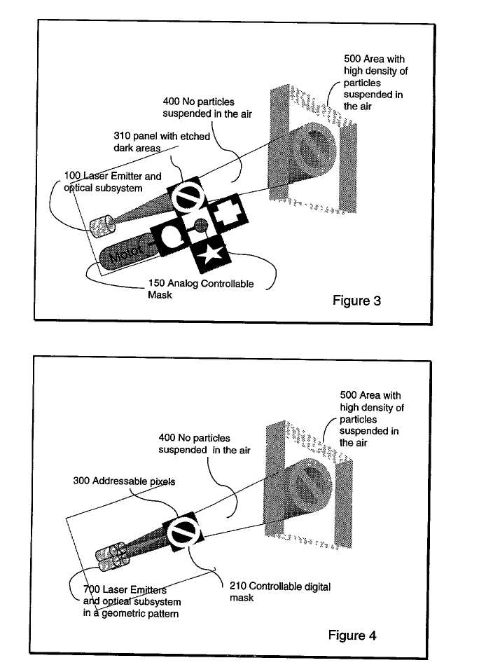

Referring now to the FIG. 4, multiple light source generator (700) emit beams towards a digital controllable mask (210) that has a plurality of addressable pixels (300). As illustrated the behavior of the projected image beam is the same as described in previous embodiments of this invention, with the difference that at the same distance of viewing from the device of this invention, the size of the projected image beam is larger. In this embodiment, the digital controllable mask (210) has a large area (footprint), divided into quadrants each in the path of the emitted beams of (700). Each of the individual light source generators (700) are organized in a geometry in which the individual laser beams cover different areas of the controllable mask (300), but provide some overlap to provide a cohesive single projected image beam.

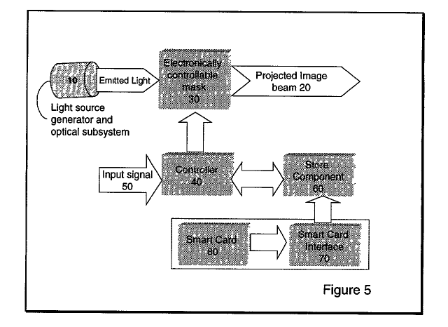

Referring now to the FIG. 5, it contains the same description of FIG. 1 and in addition the following:

70. A smart chip interface

80 A smart chip

The store component (60 of FIG. 1) loads the electronic instructions describing images, symbols, and characters of text (“Information”) that are associated to input signals (50) from an external store component that is removable, upgradeable, and changeable. The store component (60) can be implemented using RAM, or the like. A smart chip interface (70) connects the store component (60) to the smart chip (80). The smart chip is easily inserted in the image laser projector at any time. The smart chip contains electronic instructions describing images, symbols, and characters of text (“Information”) that are associated to input signals (50). Additionally, the smart chip of this invention can include firmware updates for the controller. As it is known in the art, other devices can be used in substitution of the smart chip.

Although preferred embodiments of the invention have been illustrated and described, various alternatives, modifications and equivalents may be made without departing from the spirit thereof. Therefore, the foregoing description should not be taken as limiting the scope of the inventions that are defined by the enclosed claims.

What is claimed is:

1. A device for displaying images in particles suspended in the air that can be viewed by an observer as three dimensional suspended images along a shaped beam of light, as the result of a laser light beam source passing through an electronically controllable mask or filter that shapes the laser light to create a particular image, which is stored in the device, in the suspended particles in the air (“projected image beam”), comprising:
One or more sources of light to generate, using an optical subsystem (e.g. lens), a collimated laser beam in the visible spectrum, and
An electronically digital controllable mask or filter including a plurality of selectively active (“on” or “off”, open or close) elements positioned in the paths between the source of light and the final projected image beam. Each of the selectively activate elements has the properties to block, attenuate, change the distribution, redirect, channel, or filter the spatial frequencies of the light when activated or closed. Each of the selectively activate elements respond to a respective electronic signal to block, attenuate, change the distribution, redirect, channel, or filter the spatial frequencies the passage of the light along the respective path, and
A controller (logical units) that manages one or more controllable masks to shape the light into a projected image beam with the image stored in the controller. The controller is connected to one or more input signals that singularly and collectively determine the image to be displayed.
A store component that stores the different mask images, encoded into the different input signals. The controller accesses this storing device to retrieve the instructions, associated with an input signal, to program the electronically controllable.

2. The device of claim 1 wherein the source of light comprises a laser generator for generating a laser beam in the visible spectrum that is spatially coherent.

3. The device of claim 1 wherein the source of light comprises a source for generating a soft laser beam.

4. The device of claim 1 wherein the source of light emits one or more colored laser beams in the visible spectrum.

5. The device of claim 1 wherein the source of light comprises a laser generator and an optical subsystem of one or more components to create a collimated laser beam.

6. The device of claim 1 wherein the projected image size and continuity is relative to the distance of the particles in the air from the device.

7. The device of claim 1 wherein each of the electronically controllable mask elements can be pixels, micro mirrors array, elements that change the distribution profile, filter the spatial frequencies, or other blocking technology, or the like that has the capability to substantially block, opaque, shape, change, redirect, or channel the light when activated.

8. The device of claim 1 wherein each of the electronically controllable mask can be either a clear Liquid Crystal Display (LCD) panel, micro mirror array, spatial mirror light modulator array, or rotating micro mirror.

9. The device of claim 1 wherein the electronically controllable mask includes a rotating micro mirror and a system of one or more reflecting mirrors.

10. The device of claim 1 wherein the electronically controllable mask is positioned between the source of light/optical subsystem and the projected image beam.

11. The device of claim 1 wherein the electronically controllable mask is positioned between the source of light and one or more components of the optical subsystem emitting the light.

12. The device of claim 1 wherein one or more electronically controllable masks are layered between the source of light and the projected image beam.

13. The device of claim 1 wherein the electronic controllable mask is placed orthogonal to the path of the light or beam.

14. The device of claim 1 wherein the electronic controllable mask is placed at an angle, from an orthogonal plane, to the path of the light or beam.

15. The device of claim 1 wherein the controller can be a microprocessor and firmware, an electronic circuit (logic unit), or an ASIC (Application Specific Integrated Circuit)

16. The device of claim 1 wherein the input signal is analog or digital.

17. The device of claim 1 wherein the storing device is a ROM or EPROM, a RAM component interfacing to a Smart Chip Interface.

18. The device of claim 1 wherein the store component is a Smart Chip with the image, symbols and characters stored in it.

19. A device for displaying images in particles suspended in the air, comprising: Multiple sources of light each masked by an individual electronically controllable mask and the different paths are combined into a single projected image beam.

20. The device of claim 19 wherein the source of light can be of one or more colors.

21. The device of claim 19 wherein the projected image beam consists of multiple aggregated colors.

22. A device for displaying images in particles suspended in the air, comprising:
An analog controllable mask including a plurality of predefined masks that are positioned in the path between the source of light and the final projected image beam. Each of the masks has a pattern that block, attenuate, change the distribution, or filter the spatial frequencies of the light to represent an image to be projected. Each mask can be selectively position in the path by electronic commands operating a mechanism associated to the controllable mask component.

23. The device of claim 22 wherein the analog controllable mask is made of a solid material with etched dark/opaque/transparent areas.

24. The device of claim 22 wherein the analog controllable mask can be a diffractive optical element, a diffuser lens, or other beam shaper optical element.

25. The device of claim 22 wherein the analog controllable mask contains a mechanism such as a micro motor, or the like that positions a defined mask (image) in position.

26. The device of claim 22 wherein the analog controllable mask contained mechanism has a reset sensor to identify a start position for the mechanism.

27. A device for displaying images in particles suspended in the air, comprising:
Several sources of light, organized within certain geometry, which parallel paths of light, are masked by an electronic controllable mask. Because of the geometry and overlap, the laser beams result into a single projected image beam.

28. The device of claim 27 wherein the sources of light are masked each by an individual electronic controllable mask that in its totality represents a projected image beam.

29. The device of claim 27 wherein all sources of light are masked by a single electronic controllable mask.

30. The device of claim 27 wherein the project image beam, in its totality correspond to a single projected image.
